(19) United States
(12) Patent Application Publication
(10) Pub. No.: US 2026/0233347 A1
(43) Pub. Date: Aug. 13, 2026

(54) SYSTEMS AND METHODS FOR PHOTONIC CRYSTAL INTEGRATION

(71) Applicant: Mesodyne Inc., Somerville, MA (US)

(72) Inventors: Walker Chan, Somerville, MA (US); Andrew Gilstrap, Malden, MA (US); Cassidy Dreyfus, Cambridge, MA (US); Aidan Theodore Gould, Berkeley, CA (US)

(73) Assignee: Mesodyne Inc., Somerville, MA (US)

(21) Appl. No.: 19/471,754

(22) PCT Filed: Apr. 4, 2024
(86) PCT No.: PCT/US2024/022933

§ 371 Date: Oct. 2, 2025

Related U.S. Application Data
(60) Provisional application No. 63/457,176, filed on Apr. 5, 2023.

(51) Int. Cl. B23K 35/34; B23K 103/08; B23K 103/18

(52) U.S. Cl. CPC B23K 35/34; B23K 2103/08; B23K 2103/26

(57) ABSTRACT

The present disclosure generally relates to photonic crystals, for example, for thermophotovoltaic power generation, or other applications, and to systems and methods for bonding metals or other materials together. Certain aspects are generally drawn to tantalum or other refractory metals that are bonded to Inconel or another metal superalloy. The tantalum or other refractory metals may be used as a photonic crystal in certain instances, e.g., to produce emissions when heated. In other aspects, other materials can also be used. In some cases, there may be substantially no gaps present between the materials, which may facilitate heat transfer between the materials. In some embodiments, the materials can be forced to or bonded together by heating the materials such that one material is unable to expand without exerting a force on the other material. For example, in a structure having a substantially circular cross-section, a first, inner portion comprising Inconel or another metal superalloy may be heated to force it against a second, outer portion comprising tantalum or another refractory metal, for example, because the first portion may expand faster than the second portion. This may create an interface that is substantially free of gaps. Still other aspects are generally directed to methods of using such materials, devices or kits including such structures or materials, or the like.

### RELATED APPLICATIONS

This application claims the benefit of U.S. Provisional Patent Application Ser. No. 63/457,176, filed Apr. 5, 2023, entitled “Systems and Methods for Photonic Crystal Integration,” by Chan, et al., incorporated herein by reference in its entirety.

### GOVERNMENT FUNDING

This invention was made with Government support under FA864920P1007 awarded by the US Air Force. The Government has certain rights in the invention.

### FIELD

The present disclosure generally relates to photonic crystals, for example, for thermophotovoltaic power generation, or other applications, and to systems and methods for bonding metals or other materials together.

### BACKGROUND

Photonic crystals promise near-arbitrary control of both angular and spectral emission profiles, and have been suggested for use for thermophotovoltaic power generation, or other applications. However, it can be difficult to bond photonic crystals to other materials, e.g., without the creation of gaps or spaces that can interfere with heat transfer, especially in applications such as thermophotovoltaic power generation, where temperatures can vary between room temperature (25° C.) and temperatures in the hundreds or thousands of degrees during operation. For instance, many materials expand at different rates when heated (e.g., have different thermal expansion coefficients), which may result in the creation of gaps between photonic crystals and other materials during operation, e.g., caused by a difference in thermal expansion coefficients. Accordingly, improvements are needed.

### SUMMARY

The present disclosure generally relates to photonic crystals, for example, for thermophotovoltaic power generation, or other applications, and to systems and methods for bonding metals or other materials together. The subject matter of the present disclosure involves, in some cases, interrelated products, alternative solutions to a particular problem, and/or a plurality of different uses of one or more systems and/or articles.

In one aspect, the present disclosure is generally directed to an article. In one set of embodiments, the article comprises a structure having a substantially circular cross-section. In some cases, the structure comprises an inner metal portion and an outer metal portion each being positioned circumferentially around the circular cross-section and together defining an interface therebetween. The interface may comprise a braze. In some embodiments, the inner metal portion comprises at least 90 wt % of a metal superalloy and the outer metal portion comprises at least 90 wt % of a refractory metal, and the interface has a void surface area of less than 20%.

In another set of embodiments, the article comprises a structure having a substantially circular cross-section. In some cases, the structure comprises an inner metal portion and an outer metal portion each being positioned circumferentially around the circular cross-section and together defining an interface therebetween. The interface may comprise a braze. In some embodiments, the inner metal comprises at least 90 wt % of an austenitic nickel-chromium-based superalloy and the outer metal portion comprises at least 90 wt % tantalum. In certain cases, the interface has a void surface area of less than 20%.

The article, in yet another set of embodiments, comprises a structure having a substantially circular cross-section. The structure may comprise an inner metal portion and an outer metal portion each being positioned circumferentially around the circular cross-section. In certain embodiments, the inner metal portion and the outer metal portion can be positioned within the structure such that no void gap greater than 3 micrometers exists between the inner metal portion and the outer metal portion. In one embodiment, the inner metal portion comprises at least 90 wt % of a metal superalloy and the outer metal portion comprises at least 90 wt % of a refractory metal.

The article, according to still another set of embodiments, comprises a structure comprising a first layer and a second layer. In some cases, the first layer and the second layer together define an interface therebetween. In certain embodiments, the interface comprises a braze. In one embodiment, the first layer comprises at least 90 wt % of a metal superalloy and the second layer at least 90 wt % of a refractory metal, and the interface has a void surface area of less than 20%. The article may also comprise a substantially transparent IR material, and an enclosed space having a partial pressure of oxygen of less than 10 kPa (absolute), positioned between the structure and the IR material.

According to yet another set of embodiments, the article can comprise a structure comprising a first layer and a second layer. In some cases, the first layer and the second layer together define an interface therebetween. The interface may comprise a braze. In some cases, the first layer comprises at least 90 wt % of a metal superalloy and the second layer comprises at least 90 wt % of a refractory metal, and the interface has a void surface area of less than 20%.

The article, in another set of embodiments, may be directed to a structure comprising a first layer and a second layer. In certain embodiments, the inner metal portion comprises at least 90 wt % of a metal superalloy and the outer metal portion comprises at least 90 wt % of a refractory metal. In some instances, the first layer and the second layer are positioned within the structure such that no void gap greater than 3 mm exists between the first layer and the second layer.

In yet another set of embodiments, the article may comprise a structure comprising a first layer and a second layer, where the inner metal portion comprises at least 90 wt % of a metal superalloy and the outer metal portion comprises at least 90 wt % of a refractory metal. In certain embodiments, the first layer and the second layer are positioned within the structure such that no void gap greater than 3 mm exists between the first layer and the second layer. The article may also comprise a substantially transparent IR material, and an enclosed space having a gas pressure of less than 10 kPa (absolute), positioned between the structure and the IR material.

In addition, in another aspect, the present disclosure is generally directed to a method. In accordance with one set of embodiments, the method may comprise positioning a first metal portion inside of a second metal portion, and heating to at least 800° C. the first metal portion within the second metal portion such that the first metal portion and the second metal portion contact each other. In some embodiments, the first metal portion may comprise at least 90 wt % of a metal superalloy and have a substantially circular cross-section, and the second metal portion may comprise at least 90 wt % of a refractory metal and have a substantially circular cross-section.

In another set of embodiments, the method comprises positioning a first metal portion inside of a second metal portion such that a gap between the first metal portion and the second portion does not exceed 3 mm, and heating the first and second metal portions to a temperature of at least 800° C. In some embodiments, the first metal portion can comprise at least 90 wt % of a metal superalloy and have a substantially circular cross-section, and the second metal portion can comprise at least 90 wt % of a refractory metal and have a substantially circular cross-section.

The method, in yet another set of embodiments, comprises positioning a first metal portion inside of a second metal portion, and heating the first metal portion within the second metal portion to cause the first metal portion to expand into the second metal portion until no void surface area greater than 20% remains at an interface defined between the first metal portion and the second metal portion. In certain cases, the first metal portion comprises at least 90 wt % of a metal superalloy and has a substantially circular cross-section, and the second metal portion comprises at least 90 wt % of a refractory metal and has a substantially circular cross-section.

In still another set of embodiments, the method comprises positioning a first metal portion inside of a second metal portion, and heating the first metal portion within the second metal portion such that the first metal portion exerts a pressure of at least 10 kPa on the second metal portion. In some embodiments, the first metal portion may comprise at least 90 wt % of a metal superalloy and have a substantially circular cross-section and the second metal portion may comprise at least 90 wt % of a refractory metal and have a substantially circular cross-section.

In one set of embodiments, the method comprises positioning a first metal portion inside of a second metal portion such that a gap between the first metal portion and the second portion does not exceed 500 micrometers, the first metal portion comprising at least 90 wt % of a metal superalloy and defining a closed loop, and the second metal portion comprising at least 90 wt % of a refractory metal and defining a closed loop; and heating the first and second metal portions to a temperature of at least 800° C.

In another set of embodiments, the method comprises positioning a first metal portion inside of a second metal portion, the first metal portion comprising at least 90 wt % of a metal superalloy and defining a closed loop and the second metal portion comprising at least 90 wt % of a refractory metal and defining a closed loop; and heating the first metal portion within the second metal portion to cause the first metal portion to expand into the second metal portion until no void volume greater than 1 ml/m² remains at an interface defined between the first metal portion and the second metal portion.

The method, according to yet another set of embodiments, comprises positioning a first metal portion inside of a second metal portion, the first metal portion comprising at least 90 wt % of a metal superalloy and defining a closed loop and the second metal portion comprising at least 90 wt % of a refractory metal and defining a closed loop; and heating the first metal portion within the second metal portion such that the first metal portion exerts a pressure of at least 10 kPa on the second metal portion.

In another aspect, the present disclosure encompasses methods of making one or more of the embodiments described herein, for example, articles comprising various metal portions. In still another aspect, the present disclosure encompasses methods of using one or more of the embodiments described herein, for example, articles comprising various metal portions.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a schematic diagram of a first portion, a second portion, and an interface;

FIGS. 2A-2C illustrate, in a structure having a substantially circular cross-section, a first portion being forced against a second portion; and

FIG. 3 is a plot illustrating, in a structure having a substantially circular cross-section, pressures created by heating a first portion and a second portion such that the first portion exerts a force against the second portion.

### DETAILED DESCRIPTION

The present disclosure generally relates to photonic crystals, for example, for thermophotovoltaic power generation, or other applications, and to systems and methods for bonding metals or other materials together. Certain aspects are generally drawn to tantalum or other refractory metals that are bonded to Inconel or another metal superalloy. The tantalum or other refractory metals may be used as a photonic crystal in certain instances, e.g., to produce emissions when heated. In other aspects, other materials can also be used. In some cases, there may be substantially no gaps present between the materials, which may facilitate heat transfer between the materials. In some embodiments, the materials can be forced to or bonded together by heating the materials such that one material is unable to expand without exerting a force on the other material. For example, in a structure having a substantially circular cross-section, a first, inner portion comprising Inconel or another metal superalloy may be heated to force it against a second, outer portion comprising tantalum or another refractory metal, for example, because the first portion may expand faster than the second portion. This may create an interface that is substantially free of gaps. Still other aspects are generally directed to methods of using such materials, devices or kits including such structures or materials, or the like.

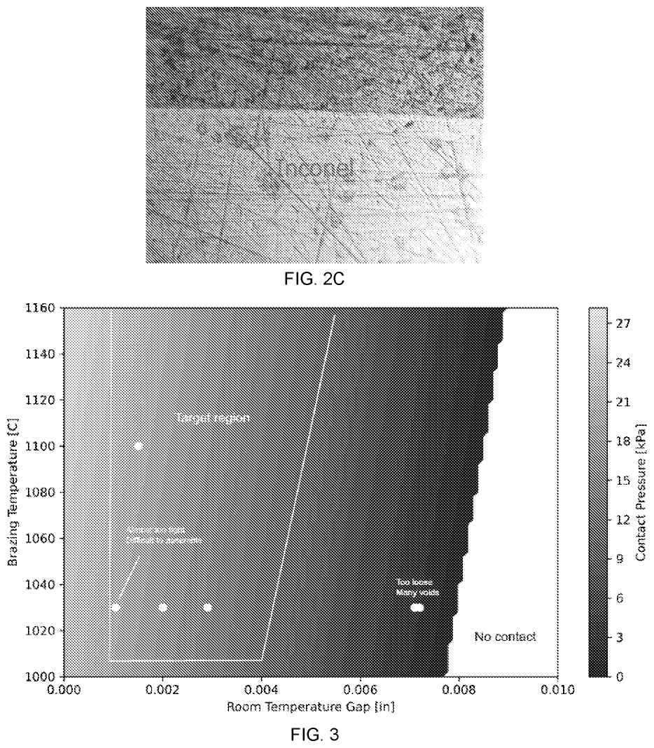

In one aspect, the present disclosure is generally directed to a device having a first portion, a second portion, and an interface defined between the first portion and the second portion. In some cases, the portions may be present within a structure as one or more layers. The layers may be generally planar, and/or may have other shapes, for example, circular layers such as is shown in FIG. 2.

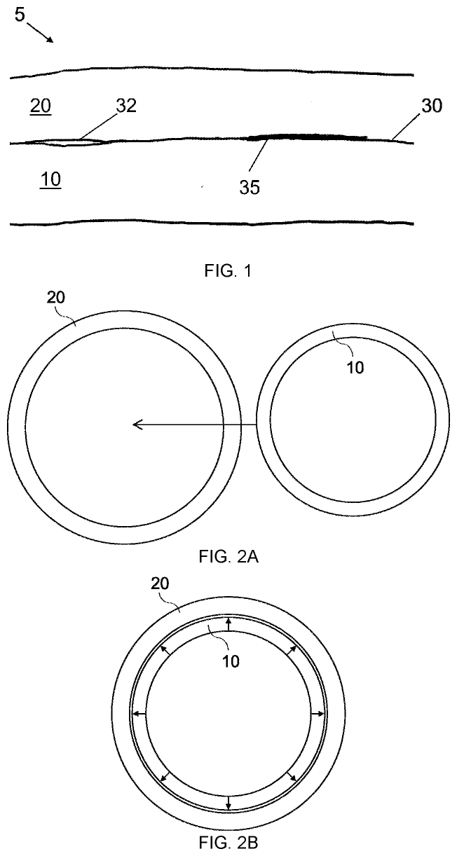

In certain applications, it may be desirable to eliminate any defects, gaps, spaces, other materials etc., that may be positioned at the interface between the first and second portions. For example, as is shown in FIG. 1, device 5 includes first portion 10, second portion 20, and interface 30 defined between the first and second portion. First portion 10 and second portion 20, in this example, appear as substantially planar layers. Interface 30 may contain gap 32 or material 35 between first portion 10 and second portion 20, and it may be desirable to avoid any such defects, gaps, spaces, etc. in interface 30.

In some cases, the first portion may contain Inconel or another metal superalloy, while the second portion may comprise tantalum or another refractory metal. The tantalum or other refractory metal may be used according to certain embodiments as a photonic crystal that, when heated, produces radiant emissions. The emissions can be received in accordance with certain embodiments by a photovoltaic cell to be converted into electrical power. The photonic crystal may also produce increasing amounts of emissions when heated. Thus, for example, a fuel may be burned to heat the Inconel or other metal superalloy, which in turn heats the tantalum or other refractory metal to cause it to emit radiation. As a non-limiting example, the first portion may be the surface of a reaction chamber (for example, a tube), in which a fuel can be burned to produce heat, and the second portion may be present as a coating covering some or all of the first portion.

However, heat transfer between the materials may be impeded in certain cases, for example, due to any defects, gaps, spaces, etc., that may be present between the materials. Accordingly, certain embodiments as generally described herein are directed to systems and methods for reducing or eliminating these, and/or for creating efficient interfaces between the materials.

For instance, in one set of embodiments, a first portion and a second portion may be positioned such that a force can be applied to force the first portion into the second portion, which may reduce or eliminate any gaps or spaces between the first and second portions. For example, a first portion positioned next to a second portion may be heated to cause the first portion to expand, such that when expansion occurs, the first portion pushes into the second portion. For example, the first portion may be heated by several hundred degrees, causing it to expand significantly, where the first portion is positioned to expand into a space at least partially occupied by the second portion. The expansion of the first portion may thus exert a pressure on the second portion, which may not be sufficiently mobile to allow the first portion to expand; thus, the second portion may resist the expansion of the first portion, thereby causing a force or pressure to be created between the materials. In some cases, the force may be quite significant, for example, such that the first portion exerts a pressure of at least 10 kPa on the second portion, or more, e.g., as discussed herein. This force may facilitate the reduction or elimination of any gaps, spaces, etc. at the interface between the materials.

In some cases, the first portion and/or the second portion may be shaped so as to facilitate this process. For example, the first portion and the second portion may be formed into shapes having substantially circular cross-sections, where the first portion is positioned inside of the second portion, e.g., such that there is a relatively small gap between the materials. In some embodiments, the first portion and/or the second portion may each be assembled from smaller portions, for example, by welding or otherwise assembling the smaller portions together using techniques such as spot welding, gas tungsten arc welding, laser welding, or other known techniques, etc.

If the first portion has a larger coefficient of thermal expansion (CTE) than the second portion and/or the first portion expands more when heated than does the second portion, then as the first portion expands, it may expand more rapidly than the second portion, filling any gaps, spaces, etc., and exerting force against the second portion, as the first portion tries to expand to a greater degree than is spatially permitted by the second portion. The forces created by this process may also help to fill in any gaps between the materials. In contrast, it is believed that other methods of forming materials comprising interfaces between materials such as Inconel and tantalum usually produces substantial gaps between the materials, especially when such materials are exposed to a wide range of temperatures.

A non-limiting example schematic of this is shown schematically in FIG. 2. In FIG. 2A, in this structure, a first material 10 has a substantially circular cross-section, and second material 20 also has a substantially circular cross-section. The materials may be shaped in the structure such that there is relatively little clearance between the materials, e.g., such that first layer barely fits inside the second layer. For instance, the gap or distance between the materials as shown in FIG. 2A may be no greater than 500 micrometers. The materials may have the forms of tubes, cylinders, spheres, or other structures having a substantially circular cross-section.

In FIG. 2B, heat may be applied to at least the first material to cause it to expand. Heat may also be applied in some cases to the second material, e.g., if the second material does not expand as much as the first material due to the increase in temperature. Because the first material may expand faster than the second material (e.g., the first material has a larger coefficient of thermal expansion than does the second material), the rate at which the outer diameter of the first material expands may be greater than the rate at which the inner diameter of the second material expands. The heating may occur until, at least, these diameters are equal, or such that the nominal outer diameter of the first material (i.e., if it were not surrounded by the second material) would otherwise be greater than the inner diameter of the second material.

However, as there is no room for further expansion of the first material due to the presence of the second material, the first material may be forced into the second material due to its continued expansion, thereby exerting a pressure on the second material. This force may be used to cause the first and second materials to bond or fuse together. In some cases, the bonding may create a relatively sharp interface between the two materials, e.g., the materials may be bonded or fused together into a unitary structure. For instance, the interface may have a void surface area of less than 20% of interface, or the interface may be sufficiently small that no void gap greater than 500 micrometers exists between the two materials. In addition, in some cases, after the heat is removed, due to the bonding between the materials, the materials may not readily separate, and instead may remain unitary. A non-limiting example is shown in FIG. 2C between a first material (Inconel) and a second material (tantalum).

The above discussion is a non-limiting example of one embodiment of the present disclosure that can be used to produce substantially defect-free interfaces between different materials. However, other embodiments are also possible. For example, certain aspects such as disclosed herein are generally directed to interfaces between a first material and a second material that are relatively defect-free.

As mentioned, certain aspects are generally drawn to metals or other materials that are bonded or fused together, as well as systems for making and using such metals or other materials. For example, some embodiments are generally drawn to structures having a first portion comprising a first material, a second portion comprising a second material, and an interface defined between the first portion and the second portion.

The first material may have a relatively large coefficient of thermal expansion (CTE), e.g., one that is larger than the coefficient of thermal expansion of the second material. In some embodiments, the first material may have a linear CTE of at least 1 um/m ° C., and in some cases, at least 2 um/m ° C., at least 3 um/m ° C., at least 5 um/m ° C., at least 7 um/m ° C., at least 10 um/m ° C., at least 11 um/m ° C., at least 12 um/m ° C., at least 13 um/m ° C., at least 14 um/m ° C., at least 15 um/m ° C., at least 16 um/m ° C., at least 17 um/m ° C., or at least 18 um/m ° C., etc. (um=micrometers).

In addition, in some cases, the first material may be one that can be heated by several hundred degrees without melting or degrading, e.g., heated to a temperature of at least about 1000° C., at least about 1500° C., or at least about 2000° C. In certain embodiments, the first material is a metal. Non-limiting examples of metals include, but are not limited to, aluminum, lead, brass, silver, copper, gold, nickel, iron, steel, or the like. In some embodiments, the material may be a metal alloy of two or more metals, e.g., including these and/or other metals.

For example, in one set of embodiments, the metal may be an Inconel or another metal superalloy, for example, an austenitic nickel-chromium-based superalloy. Non-limiting examples include Inconel 625, Inconel 617, Inconel 690, Inconel 600, Inconel 718, or Inconel X-750. These are all readily commercially available. For example, Inconel 625 has a composition 58% Ni, 20-23% Cr, 8-10% Mo, 5%, Fe, 3.15-4.15% Nb+Ta, and 1% Co. In some cases, the metal may be an alloy of nickel and chromium, optionally including other metals or materials, such as iron, molybdenum, niobium, tantalum, cobalt, manganese, copper, aluminum, titanium, silicon, carbon, sulfur, phosphorous, boron, etc.

In some cases, at least 50 wt % of the first material may comprise metal or another material (e.g., a metal superalloy such as those described herein), and in some cases, at least 60 wt %, at least 65 wt %, at least 70 wt %, at least 75 wt %, at least 80 wt %, at least 85 wt %, at least 90 wt %, at least 95 wt %, at least 99 wt %, etc., of the first material may comprise a metal or another material. In one embodiment, the first material may consist essentially of a metal superalloy, for example, an Inconel such as those described herein.

The second material may comprise a refractory metal, such as tantalum, tungsten, etc., or any other refractory metals such as those described herein. In certain embodiments, the refractory metal may be used as a photonic crystal that, when heated, produces radiant emissions. In some cases, the photonic crystal may also produce increasing amounts of emissions when heated to higher temperatures. The refractory metal may be a metal that is resistant to decomposition by heat, pressure, or chemical attack, and retains strength and form at high temperatures. For example, the refractory metal may have a melting point of at least about 1000° C., at least about 1500° C., or at least about 2000° C. One example of a refractory metal is tantalum. Another example is tungsten. Yet other non-limiting examples of refractory materials include molybdenum, niobium, osmium, iridium, ruthenium, zirconium, titanium, vanadium, chromium, rhodium, hafnium, and/or rhenium. In some cases, the refractory metal may be present as an alloy, e.g., of these and/or other metals. For example, the refractory metal may comprise two, three, four, or more metals in certain embodiments.

In some cases, at least 50 wt % of the second material may comprise a refractory metal (e.g., tantalum or tungsten, etc.), and in some cases, at least 60 wt %, at least 65 wt %, at least 70 wt %, at least 75 wt %, at least 80 wt %, at least 85 wt %, at least 90 wt %, at least 95 wt %, at least 99 wt %, etc., of the second material may comprise a refractory metal. In one embodiment, the second material may consist essentially of a refractory metal, such as tantalum or tungsten, etc.

The first material and the second material may be positioned together in a structure so as to at least partially define an interface between the materials. In some cases, the interface may have a relatively small number of defects, gaps, spaces, etc. Methods for producing such interfaces are described in more detail herein.

For example, in some embodiments, the first material and the second material may be positioned such that the interface has a relatively small void surface area of less than 30%, less than 25%, less than 20%, les than 20%, less than 15%, less than 10%, or less than 5% of the surface area of the interface. The void surface area may be taken as the area of any voids, gaps, etc. in the interface between the first and second material, as projected onto the first material. In some embodiments, there may be no detectable void surface area between the first and the second layer (for example, as is shown in FIG. 2C). Void surface areas can be determined, for example, by sectioning the material and examining the interfacial regions, e.g., microscopically.

In addition, in some cases, the first material and the second material may be positioned such that the interface has a relatively small void volume, or volume surrounded by the first material and the second material. (As a non-limiting illustrative example, in FIG. 1, first portion 10 and second portion 20 do not fully interface together, and there is a small void volume 32 defined between the portions in certain embodiments, although in other embodiments, no such void volume may be present.) For instance, in accordance with certain embodiments, the interface may have a void volume of less than 30 ml/m², less than 20 ml/m², less than 10 ml/m², less than 5 ml/m², less than 3 ml/m², less than 1 ml/m², less than 0.5 ml/m², less than 0.3 ml/m², less than 0.1 ml/m², less than 0.05 ml/m², less than 0.03 ml/m², less than 0.01 ml/m², less than 0.005 ml/m², less than 0.003 ml/m², or less than 0.001 ml/m². In some embodiments, there may be no detectable void volume between the first and the second layer (for example, as is shown in FIG. 2C). Void volumes can be determined, for example, by sectioning the material and examining the interfacial regions, e.g., microscopically.

In addition, in some embodiments, the first material and the second material may be positioned such that no void gap greater than 1 mm exists between the first material and the second material, i.e., the farthest distance the first material and the second material are positioned or separated from each other is 1 mm or less. For instance, the void gap between the first material and the second material may be less than 5 mm, less than 3 mm, less than 2 mm, less than 1 mm, less than 800 micrometers, than 700 micrometers, less than 500 micrometers, less than 300 micrometers, less than 100 micrometers, less than 50 micrometers, less than 30 micrometers, less than 10 micrometers, less than 5 micrometers, less than 3 micrometers, or less than 1 micrometer. In some embodiments, there may be no detectable gap between the first material and the second material. In addition, in some cases, there may be larger void gaps within 2 mm, 5 mm, or 10 mm of a seam of the first material and/or the second material.

In some embodiments, there may be one or more materials positioned between the first layer and the second layer, although in other embodiments, no materials may be positioned between the first layer and the second layer. As non-limiting examples, there may be one or more brazing materials (or brazes) positioned between the first layer and the second layer, e.g., at an interface. In some cases, the brazing material may comprise a metal. In some cases, the brazing material may be a material that has a lower melting point than either the first material on the second material, which may facilitate bonding of the first material and the second material. Non-limiting examples of brazing materials include metals such as nickel, aluminum, silicon, copper, silver, zinc, tin, gold, brass, bronze, or the like. In some cases, the brazing materials may be present in an amount of no more than 2000 g/m², no more than 1500 g/m², no more than 1000 g/m², no more than 500 g/m², no more than 300 g/m², no more than 200 g/m², no more than 100 mg/m², no more than 50 mg/m², no more than 30 mg/m², no more than 20 mg/m², no more than 10 mg/m², no more than 5 mg/m², no more than 3 mg/m², no more than 2 mg/m², no more than 1 mg/m², etc. of interface area. Many brazes are readily commercially available, such as BNi-2, BNi-5, and BNi-9 (Prince & Izant Co.).

A non-limiting example schematic of this is shown schematically in FIG. 2. In FIG. 2A, in this structure, a first material 10 has a substantially circular cross-section, and second material 20 also has a substantially circular cross-section. The materials may be shaped in the structure such that there is relatively little clearance between the materials, e.g., such that first layer barely fits inside the second layer. For instance, the gap or distance between the materials as shown in FIG. 2A may be no greater than 500 micrometers.

As mentioned, in one aspect, the first material and/or the second material may have a substantially circular profile, e.g., in cross-section. For example, the materials may be present in a structure having a substantially circular cross-section. The structure may have the forms of tubes, cylinders, spheres, or other structures having a substantially circular cross-section. Without wishing to be bound by any theory, it is believed that a circular profile may aid in the uniform expansion of a material, e.g., when heated, for example, to force the first material into the second material, as discussed herein, since it can be more difficult for an inner material having a substantially circular profile to expand outwardly in other directions away from an outer material. However, it should be understood that in other embodiments, the first material and/or the second material may have a profile that is not substantially circular. For example, in one set of embodiments, the first material and/or the second material may be substantially elliptical or oval, etc. The first material and/or the second material may also be planar or polygonal in certain cases. In some cases, the first material and/or the second material may define a substantially closed loop. For example, the closed loop may be an ellipse, an oval, a polygon, a rectangle, a triangle, a square, a pentagon, a hexagon, an octagon, an irregular shape, or the like.

In certain cases, the first material and/or the second material may independently have a substantially circular shape that has an inner diameter of at least 10 mm, at least 15 mm, at least 20 mm, at least 25 mm, at least 30 mm, at least 35 mm, at least 40 mm, at least 45 mm, at least 50 mm, at least 55 mm, at least 60 mm, at least 65 mm, at least 70 mm, at least 75 mm, at least 80 mm, at least 90 mm, at least 100 mm, at least 110 mm, at least 120 mm, at least 130 mm, at least 140 mm, at least 150 mm, at least 175 mm, at least 200 mm, at least 225 mm, at least 250 mm, at least 275 mm, at least 300 mm, at least 350 mm, at least 400 mm, at least 450 mm, at least 500 mm, at least 600 mm, at least 700 mm, at least 800 mm, at least 900 mm, at least 1000 mm, etc. In addition, in some embodiments, the diameter may be no more than 1000 mm, no more than 900 mm, no more than 800 mm, no more than 700 mm, no more than 600 mm, no more than 500 mm, no more than 450 mm, no more than 400 mm, no more than 350 mm, no more than 300 mm, no more than 275 mm, no more than 250 mm, no more than 250 mm, no more than 225 mm, no more than 200 mm, no more than 175 mm, no more than 150 mm, no more than 140 mm, no more than 130 mm, no more than 120 mm, no more than 110 mm, no more than 100 mm, no more than 90 mm, no more than 80 mm, no more than 75 mm, no more than 70 mm, no more than 65 mm, no more than 60 mm, no more than 55 mm, no more than 50 mm, no more than 45 mm, no more than 40 mm, no more than 35 mm, no more than 30 mm, no more than 25 mm, no more than 20 mm, no more than 15 mm, no more than 10 mm, etc. Combinations of any of these are also possible in some cases.

In some cases, the first material and/or the second material may independently have a circular profile that has an outer diameter that is larger than the inner diameter (e.g., as discussed above), and in certain embodiments, the outer diameter may be at least 10 mm, at least 15 mm, at least 20 mm, least 25 mm, at least 30 mm, at least 35 mm, at least 40 mm, at least 45 mm, at least 50 mm, at least 55 mm, at least 60 mm, at least 65 mm, at least 70 mm, at least 75 mm, at least 80 mm, at least 90 mm, at least 100 mm, at least 110 mm, at least 120 mm, at least 130 mm, at least 140 mm, at least 150 mm, at least 175 mm, at least 200 mm, at least 225 mm, at least 250 mm, at least 275 mm, at least 300 mm, at least 350 mm, at least 400 mm, at least 450 mm, at least 500 mm, at least 600 mm, at least 700 mm, at least 800 mm, at least 900 mm, at least 1000 mm, etc. In addition, in some embodiments, the diameter may be no more than 1000 mm, no more than 900 mm, no more than 800 mm, no more than 700 mm, no more than 600 mm, no more than 500 mm, no more than 450 mm, no more than 400 mm, no more than 350 mm, no more than 300 mm, no more than 275 mm, no more than 250 mm, no more than 250 mm, no more than 225 mm, no more than 200 mm, no more than 175 mm, no more than 150 mm, no more than 140 mm, no more than 130 mm, no more than 120 mm, no more than 110 mm, no more than 100 mm, no more than 90 mm, no more than 80 mm, no more than 75 mm, no more than 70 mm, no more than 65 mm, no more than 60 mm, no more than 55 mm, no more than 50 mm, no more than 45 mm, no more than 40 mm, no more than 35 mm, no more than 30 mm, no more than 25 mm, no more than 20 mm, no more than 15 mm, no more than 10 mm, etc. Combinations of any of these are also possible in some cases.

In some embodiments, as discussed herein, the first material may be positioned with respect to the second material such that there is a relatively small void gap between the first material and the second material. For instance, the void gap between the materials may be 1 mm or less. In certain embodiments, for instance, the first material may have a shape that substantially conforms to the shape of the second material, e.g., at one or more portions that defines an interface between the first and second materials.

For example, in one set of embodiments, the first material may have a surface that has a substantially circular profile, and the second material may also have a surface that has a substantially circular profile, e.g., of comparable dimensions. In such embodiments, the void gap between the materials may be determined, in some instances, by comparing the outer diameter of the first layer with the inner diameter of the second layer. For example, the difference between the diameters may be less than 2 mm, less than 1.5 mm, less than 1 mm, less than 700 micrometers, less than 500 micrometers, less than 300 micrometers, less than 100 micrometers, less than 50 micrometers, less than 30 micrometers, less than 10 micrometers, less than 5 micrometers, less than 3 micrometers, or less than 1 micrometer, etc.

As discussed, in some cases, the first material may have a larger coefficient of thermal expansion (linear and/or volumetric) than the second material and/or such that the first material expands more when heated, relative to the second material. Accordingly, if the first material and the second material each independently have a substantially circular profile, e.g., in cross-section, as the first material expands while being heated, the material may expand more quickly than the second material, and in some cases, even though the outer diameter of the first material and the inner diameter of the second material may each be expanding, the outer diameter of the first material may expand faster, e.g., until it equals the inner diameter of the second material.

Afterwards, although the first material may continue to try to expand (e.g., upon continued heating), the second material may constrain the first material from being able to expand further. In some cases, this may result in a force being applied by the first material onto the second material. In some embodiments, the force may become fairly substantial, and may result in the reduction or elimination of any gaps between the first material and the second material, thereby creating a relatively sharp interface between the materials. In addition, in some cases, the force may facilitate bonding or fusion of the first material to the second material. In certain embodiments, the force or pressure (i.e., force per unit area, e.g., of the interface) exerted by the first material onto the second material may be, on average, at least 0.5 kPa, at least 1 kPa, at least 2 kPa, at least 3 kPa, at least 5 kPa, at least 10 kPa, at least 20 kPa, at least 30 kPa, at least 50 kPa, at least 100 kPa, etc.

In certain cases, one or both of the first material and the second material may be heated to relatively large temperatures. The materials may be heated together, or separately from each other; for example, heat may be applied directly to the first material but not the second material, heat may be uniformly applied to both materials (e.g., within an oven), or the like. For instance, in one embodiment, the first material and/or the second material may be heated to temperatures of at least 200° C., at least 300° C., at least 400° C., at least 500° C., at least 600° C., at least 700° C., at least 800° C., at least 900° C., at least 1000° C., at least 1100° C., at least 1200° C., etc. In addition, in some cases, the first material and/or the second material may be heated by at least 200° C., at least 300° C., at least 400° C., at least 500° C., at least 600° C., at least 700° C., at least 800° C., at least 900° C., at least 1000° C., at least 1100° C., at least 1200° C., etc., e.g., starting from room temperature (about 25° C.). It will be noted that, because of the relatively substantial changes in temperature in accordance with certain embodiments as discussed herein, even relatively small differences in heat transfer coefficients between the two materials may result in relatively large forces being applied due to the differences in their expansions, e.g., especially if the gap between the first material and the second material was relatively small initially, such as discussed herein.

As mentioned, in certain embodiments, the first material may comprise Inconel or another metal superalloy, while the second material may comprise tantalum or another refractory metal. The tantalum or other refractory metals may be used as a photonic crystal in certain instances, e.g., to produce emissions when heated. For example, in some cases, the first material may be heated chemically, e.g., by burning or reacting a fuel, and the heat that is produced may heat the photonic crystal to emit electromagnetic radiation, which can be directed at a thermophotovoltaic cell to produce power. Non-limiting examples of fuels that can be used include gasoline, ethanol, diesel, petroleum, naphtha, hydrogen, propane, methane, coal gas, water gas, or the like. Additional non-limiting examples of fuel include heavy fuels, such as diesel, jet fuel, kerosene, or the like. Specific non-limiting examples of jet fuel include JP-8, Jet A-1, Jet-A, JP-4, Jet B, TS-1, JP-1, JP-2, JP-3, JP-5, JP-6, JP-7, JP-9, JP-10, JPTS, Zip fuel, syntroleum, or the like.

In one set of embodiments, the first material may enclose a burner for burning the fuel to produce heat, e.g., which can be passed to the second material. A variety of burner configurations may be used, e.g., to mix the fuel with oxygen (for example, from the air). One non-limiting example of such a system may be seen in U.S. Pat. Apl. Ser. No. 63/339,617, entitled “Rapid Mixing Systems and Methods for Fuel Burners,” incorporated herein by reference in its entirety.

In some cases, the emitter may also include a photonic crystal, e.g., as discussed in U.S. Pat. No. 9,116,537, incorporated by reference in its entirety. In addition, in some embodiments, the heated gases may be used to heat incoming gases, e.g., using a recuperator or a heat exchanger. For example, the photonic crystal may be present as a second material and comprise tantalum or another refractory metal, e.g., as discussed herein.

As mentioned, the heat from the reaction may be used to heat a suitable thermal power generator to produce power. For example, a photonic crystal may be heated from the reaction. The photonic crystal may be part of an emitter that emits electromagnetic radiation, which can be directed at a thermophotovoltaic cell to produce power.

A photonic crystal may be associated with the emitter to achieve selective emission of electromagnetic radiation from the emitter, in some embodiments. Those of ordinary skill in the art would be familiar with photonic crystals, which include periodic optical structures that allow certain wavelengths of electromagnetic radiation to be propagated through the photonic crystal structure, while other wavelengths of electromagnetic radiation are confined within the volume of the photonic crystal. This phenomenon is generally referred to in the art as a photonic band gap. The photonic crystal can be fabricated directly on the emitter or fabricated separately and integrated with the emitter as a separate step.

The photonic crystal associated with the emitter can have, in some cases, 1-dimensional periodicity. One of ordinary skill in the art would be able to determine the dimensionality of the periodicity of a photonic crystal upon inspection. For example, 1-dimensionally periodic photonic crystals include materials arranged in such a way that the index of refraction within the volume of the photonic crystal varies along one coordinate direction and does not substantially vary along two orthogonal coordinate directions. For example, a 1-dimensionally periodic photonic crystal can include two or more materials arranged in a stack within the emitter such that there is substantially no variation in the index of refraction along two orthogonal coordinate directions. 2-dimensionally periodic photonic crystals include materials arranged in such a way that the index of refraction within the volume of the photonic crystal varies along two coordinate directions and does not substantially vary along 1 coordinate direction orthogonal to the other two coordinate directions.

Any suitable materials can be used to form an emitter. For example, the emitter can comprise a semiconductor (e.g., silicon, germanium), a metal (e.g., tungsten), a dielectric material (e.g., titanium dioxide, silicon carbide) and the like. In some embodiments, all or part of the emitter can be made from a refractory metal (e.g., niobium, molybdenum, tantalum, tungsten, osmium, iridium, ruthenium, zirconium, titanium, vanadium, chromium, rhodium, hafnium, and/or rhenium) and/or another refractory material. The use of refractory materials can allow one to fabricate an emitter that is capable of withstanding relatively high temperatures (e.g., at least about 1000° C., at least about 1500° C., or at least about 2000° C.). In some embodiments, all or part of the emitter can be made of compounds such as tungsten carbide, tantalum hafnium carbide, and/or tungsten boride. In some embodiments, all or part of the emitter can be made from noble metals, including noble metals with high melting points (e.g., platinum, palladium, gold, and silver), diamond, and/or cermets (e.g., compound metamaterials including two or more materials (e.g., tungsten and alumina) which can be, in some embodiments, broken up into pieces smaller than the wavelength of visible light). In some embodiments, all or part of the emitter can be made from a combination of two or more of these materials.

The emitter can also include a photonic crystal in certain embodiments. The photonic crystal, in some embodiments, may include a first material with a first index of refraction proximate a base, a second material with a second index of refraction between the base and the first material, and a third material with a third index of refraction between the base and the second material. Additional layers are also possible in some embodiments.

In some embodiments, the materials within a 1-dimensionally periodic photonic crystal can be arranged such that the material occupying the outermost surface of the photonic crystal has the lowest index of refraction of the photonic crystal materials. The indices of refraction of the materials can, in some cases, increase along a path starting at the outermost surface of the photonic crystal and extending toward the base of the emitter. In some cases, the index of refraction of the second material can be at least about 1.1, at least about 1.5, at least about 2, between about 1.1 and about 2, or between 1.1 and about 1.5 times greater than the index of refraction of the first material. The index of refraction of the third material can be, in some embodiments, at least about 1.1, at least about 1.5, at least about 2, between about 1.1 and about 2, or between 1.1 and about 1.5 times greater than the index of refraction of the second material. Fourth, fifth, sixth, and subsequent materials, positioned between the first three layers and the base can have indices of refraction that are progressively higher than those of preceding material. In some embodiments, the indices of refraction of the materials within the 1-dimensionally periodic photonic crystal can increase exponentially along a path starting at the outermost surface of the photonic crystal and extending toward the base of the emitter. Arranging the materials of the photonic crystal in this manner can enhance the degree to which desirable wavelengths of electromagnetic radiation are emitted from the emitter, while reducing the degree to which unwanted wavelengths are emitted.

In some embodiments, the photonic crystal can comprise an integer number of m materials (e.g., m layers of materials) labeled such that the material given an index of i=1 is closest to the base and farthest from the emission surface and the material given an index of i=m (i.e., the m^{th} material) is closest to the emission surface (e.g., the outermost surface of the photonic crystal). One of ordinary skill in the art would understand that, when counting the number of photonic crystal materials, materials that do not contribute to the bandgap function of the photonic crystal would not be counted. For example, an adhesion layer between photonic crystal layers would not be counted.

In some cases, the photonic crystal may include a plurality of bi-layers. In some embodiments, the bi-layer farthest from the base (or closest to the emission surface) has the shortest period, while the bi-layer closest to the base (or farthest from the emission surface) has the longest period. In some cases, the 1-dimensionally periodic photonic crystal can be constructed such that the periods of the bi-layers increase substantially exponentially in a direction from the bi-layer farthest from the base (or closest to the emission surface) to the bi-layer closest to the base (or farthest from the emission surface). For example, in some embodiments, the photonic crystal can include m bi-layers numbered from the bi-layer closest to the emission surface to the bi-layer farthest from the emission surface.

The 1-dimensionally periodic photonic crystals described above can include a variety of suitable types of materials. Examples of materials suitable for use in the 1-dimensionally periodic photonic crystals include, but are not limited to, silicon, silicon dioxide, silicon nitride, metals (e.g., steel, tungsten, tantalum, platinum, palladium, silver, gold, etc.), metal oxides (e.g., alumina, zirconia, titania), cermets (e.g., aluminum based cermets such as Ni-Al₂O₃ cermets), and the like. As one specific example, the 1-dimensionally periodic photonic crystal can comprise bi-layers, each bi-layer containing a layer of silicon and a layer of silicon dioxide. As another specific example, the 1-dimensionally periodic photonic crystal can comprise a plurality of layers of tungsten-silica cermet and/or a plurality of layers of tungsten-alumina cermet.

In some embodiments, the photonic crystal may include layers of material adjacent the top surface of a base. These layers can be formed as thin films (e.g., films with average thicknesses of less than about 100 microns and, in some cases, less than about 10 microns, or less than about 1 micron). In some cases, it can be advantageous for the photonic crystal to be positioned over the entire external surface of the emitter to prevent unwanted wavelengths of electromagnetic radiation from being emitted. However, it should be understood that, in other embodiments, the materials within the photonic crystal might not be formed as layers, and might not be positioned over the entire external surface of the emitter. For example, the TPV cell might have a smaller exposed surface area than the external surface area of the emitter, in which case, the photonic crystal might only occupy a portion of the emitter surface while the rest of the emitter surface is coated with a material constructed and arranged to reflect substantially all of the electromagnetic radiation generated by the emitter.

As used herein, two materials (e.g., layers of materials) are “proximate” when they are sufficiently close to retain their desired functionality. In some embodiments, two materials can be proximate when they are positioned in direct contact with each other. In some instances, two materials can be proximate while one or more other materials are positioned between them.

In some embodiments, the photonic crystal associated with the emitter can include 2-dimensional periodicity. The 2-dimensionally periodic photonic crystals can include any suitable type of material. Examples of materials that can be used to form the 2-dimensionally periodic photonic crystal include, but are not limited to, metals (e.g., tungsten (e.g., single-crystal tungsten), tantalum, platinum, palladium, silver, gold, etc.), semiconductors (e.g., silicon, germanium, etc.), or dielectrics (e.g., titania, zirconia).

In some embodiments, all or part of the 1-dimensionally periodic photonic crystal and/or the 2-dimensionally periodic photonic crystal can be made from a refractory metal (e.g., niobium, molybdenum, tantalum, tungsten, osmium, iridium, ruthenium, zirconium, titanium, vanadium, chromium, rhodium, hafnium, and/or rhenium) and/or another refractory material. The use of refractory materials can allow one to fabricate a photonic crystal that is capable of withstanding relatively high temperatures (e.g., at least about 1000° C., at least about 1500° C., or at least about 2000° C.). In some embodiments, all or part of the 1-dimensionally periodic photonic crystal and/or the 2-dimensionally periodic photonic crystal can be made of compounds such as tungsten carbide, tantalum hafnium carbide, and/or tungsten boride. In some embodiments, all or part of the 1-dimensionally periodic photonic crystal and/or the 2-dimensionally periodic photonic crystal can be made from noble metals, including noble metals with high melting points (e.g., platinum, palladium, gold, and silver), diamond, and/or cermets (i.e., compound metamaterials including two or more materials (e.g., tungsten and alumina) which can be, in some embodiments, broken up into pieces smaller than the wavelength of visible light). In some embodiments, all or part of the 1-dimensionally periodic photonic crystal and/or the 2-dimensionally periodic photonic crystal can be made from a combination of two or more of these materials.

In one aspect, the photonic crystal may be present within an enclosed or sealed environment, e.g., to prevent leakage of gases from occurring into or out of an interior region containing the photonic crystal. In some embodiments, a first substrate may at least partially enclose an interior region, wherein the photonic crystal is partially or completely positioned within the interior region of the first substrate. The first substrate may have any suitable shape, e.g., tubes, cylinders, spheres, or other structures.

The enclosed or sealed environment, in certain embodiments, may contain a vacuum, and/or may contain gases that have very low concentrations of oxygen and/or water vapor. One of ordinary skill in the art will understand the meaning of vacuum. In some cases, vacuum indicates a region with a pressure lower than atmospheric or ambient pressure, but the vacuum is not required to be a “perfect” vacuum (i.e., containing zero molecules). For example, according to some embodiments, the vacuum may have a pressure (absolute) of less than 100 kPa, less than 10 kPa, less than 10⁻¹ kPa, less than 10⁻² kPa, less than 10⁻³ kPa, less than 10⁻⁴ kPa, less than 10⁻⁵ kPa, less than 10⁻⁶ kPa, less than 10⁻⁷ kPa, or less than 10⁻⁸ kPa at room temperature. In some embodiments, the partial pressure of water vapor and/or oxygen within the vacuum may be less than 100 kPa, less than 10 kPa, less than 10⁻¹ kPa, less than 10⁻² kPa, less than 10⁻³ kPa, less than 10⁻⁴ kPa, less than 10⁻⁵ kPa, less than 10⁻⁶ kPa, less than 10⁻⁷ kPa, or less than 10⁻⁸ kPa at room temperature, etc.

In some embodiments, it may be advantageous for the first substrate to comprise an IR-transparent material. In certain embodiments, at least 50%, at least 60%, at least 70%, at least 80%, at least 90%, at least 95%, or at least 99% of the first substrate may comprise one or more IR-transparent materials. In some cases, the transmittance of the material of the first substrate may be at least 0.5, at least 0.6, at least 0.7, at least 0.75, at least 0.8, at least 0.85, at least 0.9, at least 0.95, or at least 0.99 for radiation corresponding to IR radiation (e.g., radiation having a wavelength of at least 700 nm, at least 800 nm, at least 900 nm, at least 1 micron, at least 1.2 microns, at least 1.5 microns, at least 1.8 microns, or at least 2 microns, etc.). Thus, in some cases, the photonic crystal may be heated and selectively emit radiation, where the photonic crystal may be positioned to emit the radiation through the interior region and/or through the first substrate enclosing the interior region. Thus, in accordance with some embodiments, the first substrate may at least partially comprise an IR-transparent material so that the radiation emitted by the photonic crystal may not be substantively impeded by the first substrate (e.g., absorbed and/or reflected by the first substrate), for example, having transmittances such as those described herein. For example, in some cases, the first substrate may comprise a ceramic material. In some embodiments, the first substrate may comprise a material such as sapphire and/or quartz.

U.S. Pat. Apl. Ser. No. 63/339,617, entitled “Rapid Mixing Systems and Methods for Fuel Burners,” filed May 9, 2022, is incorporated herein by reference in its entirety. In addition, U.S. Pat. Apl. Ser. No. 63/457,179, entitled “Passivation Systems and Methods for Photonic Crystals,” and U.S. Pat. Apl. Ser. No. 63/457,183, entitled “Vacuum Packaging for Photonic Crystals and Methods Thereof,” each filed on Apr. 5, 2023, are also each incorporated herein by reference in its entirety. Also, U.S. Pat. Apl. Ser. No. 63/457,176, filed Apr. 5, 2023, entitled “Systems and Methods for Photonic Crystal Integration,” is also incorporated herein by reference in its entirety.

The following examples are intended to illustrate certain embodiments of the present disclosure, but do not exemplify the full scope of the disclosure.

### EXAMPLE 1

For each experiment, two photonic crystals were fabricated on 6 inch diameter wafers of 0.015 inch (0.381 mm) thick tantalum using standard microfabrication techniques. An Inconel tube was ground to a precise 1.962 inch diameter (49.835 mm). First the wafers were formed to the correct size to eventually form the needed cylinders. Each sheet was then rolled to the approximate desired radius using a sheet metal rolling machine. The final forming step was the formation of the jog geometry to allow for a lap joint at the seams, using a standard rubber pad forming process. The two half-cylinders were assembled and spot welded into a closed cylinder around a mandril, then brazed, although other processes such as gas tungsten arc welding or laser welding processes could also be used. In some cases, the mandril may be the burner tube itself. During the assembly step, the diameter was adjusted slightly to achieve the target room temperature gap. The cylinder of photonic crystal was slipped over the Inconel tube with a layer of BNi-2 braze alloy between the two. Instead of a mandril, the photonic crystal may also be brazed or welded around the Inconel tube itself, potentially with a spacer to adjust diameter. The assembly was brazed in a furnace to form the finished part.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An article, comprising:
a structure having a substantially circular cross-section, the structure comprising an inner metal portion and an outer metal portion each being positioned circumferentially around the circular cross-section and together defining an interface therebetween, the interface comprising a braze,
wherein the inner metal portion comprises at least 90 wt % of a metal superalloy and the outer metal portion comprises at least 90 wt % of a refractory metal, and the interface has a void surface area of less than 20%.

2. The article of claim 1, wherein the substantially circular cross-section has an outer diameter of less than 15 cm.

3. The article of any one of claims 1 or 2, wherein the inner metal portion comprises at least 95 wt % of the metal superalloy.

4. The article of any one of claims 1-3, wherein the inner metal portion consists essentially of the metal superalloy.

5. The article of any one of claims 1-4, wherein the metal superalloy is an austenitic nickel-chromium-based superalloy.

6. The article of any one of claims 1-5, wherein the metal superalloy comprises Inconel.

7. The article of any one of claims 1-6, wherein the metal superalloy comprises Inconel 625.

8. The article of any one of claims 1-7, wherein the outer metal portion comprises at least 95 wt % of the refractory metal.

9. The article of any one of claims 1-8, wherein the outer metal portion consists essentially of the refractory metal.

10. The article of any one of claims 1-9, wherein the refractory metal comprises tantalum.

11. The article of any one of claims 1-10, wherein the refractory metal comprises tungsten.

12. The article of any one of claims 1-11, wherein the interface comprises nickel.

13. The article of any one of claims 1-12, wherein the inner metal portion and the outer metal portion are positioned within the structure such that no void gap greater than 3 mm exists between the inner metal portion and the outer metal portion.

14. The article of any one of claims 1-13, wherein the inner metal portion and the outer metal portion are positioned within the structure such that no void gap greater than 500 micrometers exists between the inner metal portion and the outer metal portion.

15. The article of any one of claims 1-14, wherein at least a portion of the structure is positioned within a tube comprising a substantially transparent IR material.

16. The article of any one of claims 1-15, wherein the tube comprises sapphire.

17. The article of any one of claims 1-16, wherein the tube comprises quartz.

18. An article, comprising:
a structure having a substantially circular cross-section, the structure comprising an inner metal portion and an outer metal portion each being positioned circumferentially around the circular cross-section and together defining an interface therebetween, the interface comprising a braze,
wherein the inner metal comprises at least 90 wt % of an austenitic nickel-chromium-based superalloy and the outer metal portion comprises at least 90 wt % tantalum, and wherein the interface has a void surface area of less than 20%.

19. An article, comprising:
a structure having a substantially circular cross-section, the structure comprising an inner metal portion and an outer metal portion each being positioned circumferentially around the circular cross-section, the inner metal portion and the outer metal portion positioned within the structure such that no void gap greater than 3 micrometers exists between the inner metal portion and the outer metal portion,
wherein the inner metal portion comprises at least 90 wt % of a metal superalloy and the outer metal portion comprises at least 90 wt % of a refractory metal.

20. The article of claim 19, wherein the inner metal portion and the outer metal portion are positioned within the structure such that no void gap greater than 3 micrometers exists between the inner metal portion and the outer metal portion except within 5 mm of a seam of the outer metal portion.

21. The article of any one of claims 19 or 20, wherein the inner metal portion and the outer metal portion are positioned within the structure such that no void gap greater than 500 micrometers exists between the inner metal portion and the outer metal portion.

22. An article, comprising:
a structure comprising a first layer and a second layer, the first layer and the second layer together defining an interface therebetween, the interface comprising a braze, wherein the first layer comprises at least 90 wt % of a metal superalloy and the second layer at least 90 wt % of a refractory metal, and the interface has a void surface area of less than 20%;
a substantially transparent IR material; and
an enclosed space having a partial pressure of oxygen of less than 10 kPa (absolute), positioned between the structure and the IR material.

23. An article, comprising:
a structure comprising a first layer and a second layer, the first layer and the second layer together defining an interface therebetween, the interface comprising a braze, wherein the first layer comprises at least 90 wt % of a metal superalloy and the second layer comprises at least 90 wt % of a refractory metal, and the interface has a void surface area of less than 20%.

24. An article, comprising:
a structure comprising a first layer and a second layer, wherein the inner metal portion comprises at least 90 wt % of a metal superalloy and the outer metal portion comprises at least 90 wt % of a refractory metal, wherein the first layer and the second layer are positioned within the structure such that no void gap greater than 3 mm exists between the first layer and the second layer.

25. An article, comprising:
a structure comprising a first layer and a second layer, wherein the inner metal portion comprises at least 90 wt % of a metal superalloy and the outer metal portion comprises at least 90 wt % of a refractory metal, wherein the first layer and the second layer are positioned within the structure such that no void gap greater than 3 mm exists between the first layer and the second layer;
a substantially transparent IR material; and
an enclosed space having a gas pressure of less than 10 kPa (absolute), positioned between the structure and the IR material.

26. A method, comprising:
positioning a first metal portion inside of a second metal portion, the first metal portion comprising at least 90 wt % of a metal superalloy and having a substantially circular cross-section and the second metal portion comprising at least 90 wt % of a refractory metal and having a substantially circular cross-section; and
heating to at least 800° C. the first metal portion within the second metal portion such that the first metal portion and the second metal portion contact each other.

27. A method, comprising:
positioning a first metal portion inside of a second metal portion such that a gap between the first metal portion and the second portion does not exceed 3 mm, the first metal portion comprising at least 90 wt % of a metal superalloy and having a substantially circular cross-section, and the second metal portion comprising at least 90 wt % of a refractory metal and having a substantially circular cross-section; and
heating the first and second metal portions to a temperature of at least 800° C.

28. A method, comprising:
positioning a first metal portion inside of a second metal portion, the first metal portion comprising at least 90 wt % of a metal superalloy and having a substantially circular cross-section and the second metal portion comprising at least 90 wt % of a refractory metal and having a substantially circular cross-section; and
heating the first metal portion within the second metal portion to cause the first metal portion to expand into the second metal portion until no void surface area greater than 20% remains at an interface defined between the first metal portion and the second metal portion.

29. A method, comprising:
positioning a first metal portion inside of a second metal portion, the first metal portion comprising at least 90 wt % of a metal superalloy and having a substantially circular cross-section and the second metal portion comprising at least 90 wt % of a refractory metal and having a substantially circular cross-section; and
heating the first metal portion within the second metal portion such that the first metal portion exerts a pressure of at least 10 kPa on the second metal portion.
